(19) United States
(12) Patent Application Publication
(10) Pub. No.: US 2005/0080697 A1
(43) Pub. Date: Apr. 14, 2005

(54) System, method and apparatus for providing financial services

(76) Inventors: Sheldon H. Foss JR., Suwanee, GA (US); Dennis H. James JR., Atlanta, GA (US)

Correspondence Address: LAVA GROUP LAW BY SMITH & FROHWEIN, LLC, P.O. BOX 88148, ATLANTA, GA, 30356, US

(21) Appl. No.: 10/685,277

(22) Filed: Oct. 14, 2003

(51) Int. Cl. G06F 17/60

(52) U.S. Cl. 705/35

(57) ABSTRACT

The present invention is a system, method and apparatus for a terminal capable of accepting debit/credit or ATM cards, checks, money orders, cashiers checks, travelers checks, as well as a drivers license, state identification card, birth certificate and additionally any type of information that may be inputted into the terminal such as, but not limited to, an individuals direct deposit account (DDA) number, savings account number, etc. to facilitate a purchase, transfer of funds, wire of funds, cash-back option, etc. at a merchant location. In addition, the present invention will allow an individual to purchase pre-paid credit-type cards, pre-paid telecom cards, stamps, etc. at the terminal.

### CROSS REFERENCE TO RELATED APPLICATIONS

The present invention is related to and incorporates by reference the following applications for United States patents:
System for Providing a Checkless Checking Account filed on Aug. 22, 2003 and assigned Ser. No. 10/645,949; and
System and Method for Dynamically Managing a Financial Account filed on Aug. 22, 2003 and assigned Ser. No. 10/646,150.

### TECHNICAL FIELD

The present invention relates to banking industries and, more particularly, to providing multiple financial services to consumers through a terminal located at merchant facilities and networked into a server and a structure for compensating the merchant.

### BACKGROUND OF THE INVENTION

Throughout the years, a main focus providing services to consumers has been convenience. It is quite clear to even the most simplistic marketing analyst that the more convenient you can make a service to the consumer, the more likely the consumer will partake in the service. It is on this foundation that the majority of Internet services are based.

The Internet is not always the final answer in providing convenience to the consumer. In some instances, consumers are simply reluctant to conduct business over the Internet due to a variety of reasons, such as fear of losing confidentiality, resistance to relying on modern technology and sometimes, just stubbornness. Thus, there has been, is and remains a need in the art for providing face to face, plain old ordinary customer service.

The banking and credit industry is particularly poised in this predicament. Consumers that are engaging in financial transactions or receiving financial services often times prefer to deal with an institution rather than the Internet. Thus, marketers are still challenged with increasing the convenience at which such services are offered.

One avenue that has been extensively explored for providing financial services is through merchants. Consumers typically are willing to trust a merchant that is offering a financial service. This is evident in the fact that nearly every department store offers a credit program to their customers.

Typically, merchants are limited to the types of financial services that they can provide. This limitation can be due to a variety of factors including the cost that the merchant must incur to provide the service, the technological complexities of providing the service, and the training required for the merchant's employees. However, anyone that has completed a marketing 101 class will agree that the more services a merchant can offer, the more foot traffic the merchant will generate and thus, the higher probability the merchant will get a sale.

Thus, there is a need in the art for a solution that enables a merchant to provide multiple financial services to its customers that is commercially feasible to the merchant, not overly complicated from a technological perspective, and that minimizes the training required for the merchant's employees.

### SUMMARY OF THE INVENTION

The present invention is a unique and novel solution to these needs in the art and includes a system, method and apparatus for providing a multi-functional terminal that can provide a plurality of financial services to a customer.

The present invention includes a multi-functional terminal that allows a merchant to provide a plurality of financial services to a customer. The multi-functional terminal is operable to accept, read and process a variety of items including, but not limited to, debit/credit or ATM cards, checks, money orders, cashiers checks, travelers checks, as well as a drivers licenses, state identification cards, and birth certificates. In addition, the multi-functional terminal can accept a variety of types of information that may be input, such as but not limited to, an individual's direct deposit account (DDA) number, savings account number, etc. The multi-functional terminal also operates to facilitate a purchase, transfer of funds, wire of funds, cash-back option, etc. at a merchant location. The multi-functional terminal advantageously can be used at a merchant location to allow an individual to purchase pre-paid credit-type cards, pre-paid telecom cards, stamps, etc. at the terminal.

In operation, the multi-functional terminal of the present invention comprises a data interface, a processor and a network interface. The data interface interfaces to a plurality of data sources to extract data needed for a particular financial service. The network interface interfaces to a plurality of networks, servers or an individual network or server to obtain verification or authorization information utilized in providing a particular financial service. The processor will control the data flow from the data interface to the network interface, analyze the data and determine the data required for any particular financial service, create account information if necessary, verify data and enable and perform financial services, update the data after completing a financial service if necessary, and any other financial service related processing.

The data interface component operates to obtain the data necessary to perform the financial service selected by the individual. Several techniques can be employed to obtain the data and although there are preferred techniques described herein, the present invention should not be limited to any particular technique. Advantageously the present invention has the capability of collecting an initial deposit of funds from an individual at the same time as the data is collected in the case of the purchase of a pre-paid credit-type card or phone card. The data collected can include, but is not limited to, information such as the customer's name, date of birth, contact information, government identification such as a Social Security Number, financial status, marital status, employment history, references, or the like. In addition, some level of prior behavior such as the customer's insufficient funds history maybe included. The system may also run a credit check on new or renewing customers.

Another aspect of the invention is the collection of the data. The collection may be performed by a number of different methods including, but not limited to, a magnetic type device, a bar code reader, a scanner, a templated scanner, a keyboard, a touch-screen, a microphone, a bio-metric reader, etc. Basically, any item that may contain individual information can be collected by the data interface. The data interface is universal so that any data source may be utilized to supply data.

Another aspect of the invention is the data processing. The processor may require specific data for any particular financial transaction. Once the financial service is established the processor analyzes the data to determine if the appropriate data is present. If additional data is required, the processor will notify the individual or merchant. The processor can analyze and sort the data to extract the required information. In addition, the processor may analyze the data source to determine what data is present on the source and additionally, where on the data source the data is present. For example, one technique, when a templated scanner is utilized to collect data, the processor will first determine the type of data source, i.e. a drivers license, social security card, etc. Then, the processor will associate a template with the particular type of data source to extract the necessary data from that source to perform the selected financial service. Then, the pertinent data will be utilized in the particular financial service. Several techniques can be employed to obtain the data and although there are preferred techniques described herein, the present invention should not be limited to any particular technique.

### BRIEF DESCRIPTION OF THE DRAWINGS

Other aspects, advantages and novel features of the invention will become more apparent from the following detailed description of exemplary embodiments of the invention when considered in conjunction with the accompanying drawings wherein:

FIG. 1 is a diagram illustrating an exemplary embodiment of a terminal that facilitates the provision of a variety of financial services.

FIG. 2 is a flow diagram illustrating an overview of the steps and components that can be utilized in conjunction with implementing various embodiments of the present invention.

FIG. 3 is a flow diagram illustrating the processes involved in providing the financial service of issuing a cash card to a customer through the use of the multi-functional terminal of the present invention.

FIG. 4 is a flow diagram illustrating the operation of an exemplary embodiment of the present invention.

### DETAILED DESCRIPTION

In general, the present invention can be described as a novel system, method and apparatus for a merchant to conveniently provide a variety of financial services to a consumer. The exemplary embodiments described below are for illustrative purposes only and, a person skilled in the art will construe them broadly. It should be understood that the features and aspects of the present invention can be ported into a variety of systems and system/network configurations and any examples provided within this description are for illustrative purposes only. Referring now to the figures, in which like numerals refer to like elements throughout the several views, exemplary embodiments of the present invention are described.

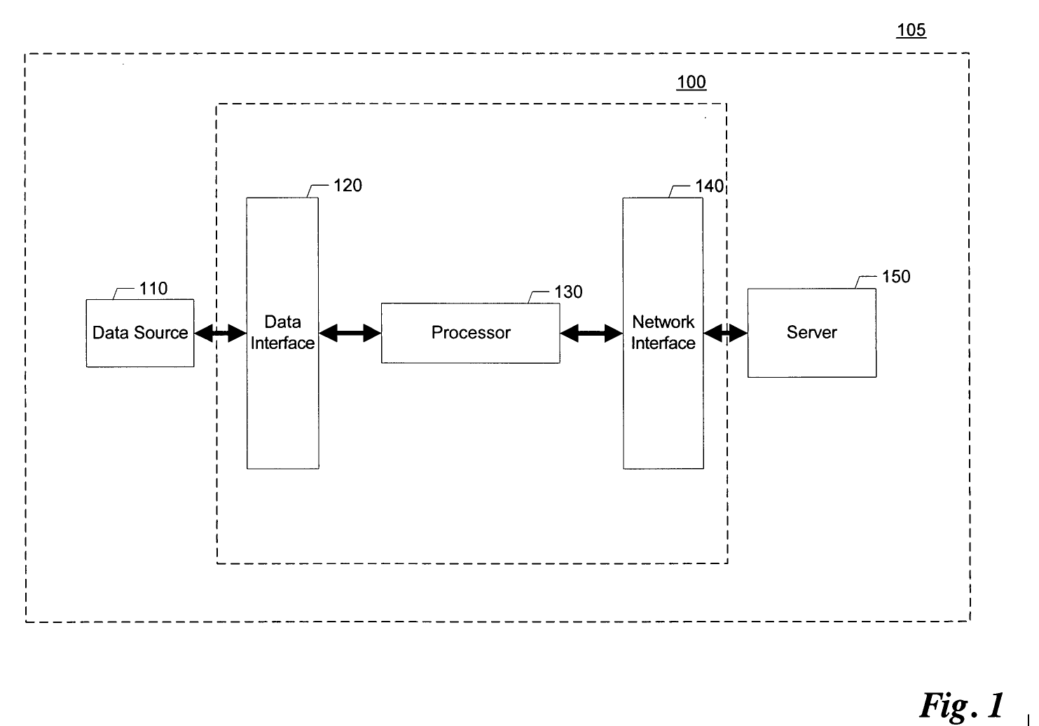

FIG. 1 is a diagram illustrating an exemplary embodiment of a terminal 100 that facilitates the provision of a variety of financial services. The terminal 100 is comprised of a processor 130, a data interface 120 and a network interface 140.

The data interface 120 is coupled both to the processor 130 and can interface to a data source 110. One function of the data interface 120 is to extract session data from the data source 110 and transfer the session data to the processor 130. Another function of the data interface 120 is transferring modified session data from the processor 130 to the data source 110. Thus, in some embodiments, the data interface 120 can transfer data bi-directionally. The data interface 120 may be any type of interface capable of extracting and/or writing to a data source 110. The data interface 120 may incorporate the hardware necessary to read/write to the data source 110 or may simply be an interface to a hardware device such as a bar code reader/writer, a magnetic reader/writer, a scanner, a templated scanner, a printer, a bio-metric identification device, a pass-through inlet/outlet, etc. Further, the data source 110 may consist of many different types of sources, including, but not limited to, a bar code, a magnetic-type card or magnetic storage device, scannable media, writable media, a fingerprint, a keyboard or keypad, a mouse, a light-pen, a touch pad, a display, or any other type of data device. The session data is data that may be utilized in a particular financial service transaction. The session data may be located on the data source 110, or alternatively, may be inputted manually. The session data may include, but is not limited to, name, date of birth, address, telephone number, social security number, verified government identification, direct deposit account (DDA) information and number, savings account information and number, credit history, debt to credit ratio, asset information, a type of financial service, a transaction amount, card account number, etc.

The network interface 140 is coupled to the processor 130 and interfaces to a server 150. One function of the network interface 140 is to provide session data to the server 150. Another function of the network interface 140 is obtaining validation from the server 150 and providing it to the processor 130. The server 150 validates all or a portion of the session data for a variety of different purposes depending on the particular financial service involved. The validation may include, but is not limited to, an approval for a financial service, a denial for a financial service, an available balance or fund verification, a credit worthiness verification, a billing address verification, etc.

The processor 130 is coupled to both the data interface 120 and the network interface 140. One function of the processor 130 is processing the session data and executing or initiating the provision of a plurality of financial services. The processor 130 receives the session data from the data interface 120 and requests a validation from the server 150, based at least in part on the session data, through the network interface 140. Further, the processor 130 provides or initiates the provision of a plurality of financial services and in some embodiments, is capable of updating the session data stored on the data source 110 based at least in part on the provision of the particular financial service. The plurality of financial services may include, but are not limited to, purchasing pre-paid cards, pre-paid card acceptance, credit card acceptance, debit card acceptance, check acceptance, point of sale purchase, cash back on point of sale purchase, transfers, card-to-card activity, bill payment, loyalty acceptance, etc.

FIG. 1 also illustrates the multi-functional terminal 100 within a system for providing financial services 105. The system 105 includes: the terminal 100, a server 150 and one or more data sources 110. In operation, the multi-functional terminal 100 is provided to a merchant for use in store operation. The terminal 100 is interfaced to and granted access to the server 150. The interface to the server 150 can be provided in a variety of fashions including, but not limited to, DSL, T1, broadband, wireless, telephonic and satellite connectivity. The multi-functional terminal 100 is available to merchant employees in providing the financial services to customers. Depending on the desired financial service, a customer obtains and/or presents a data source 110 to the merchant in conjunction with selecting a financial service to be provided.

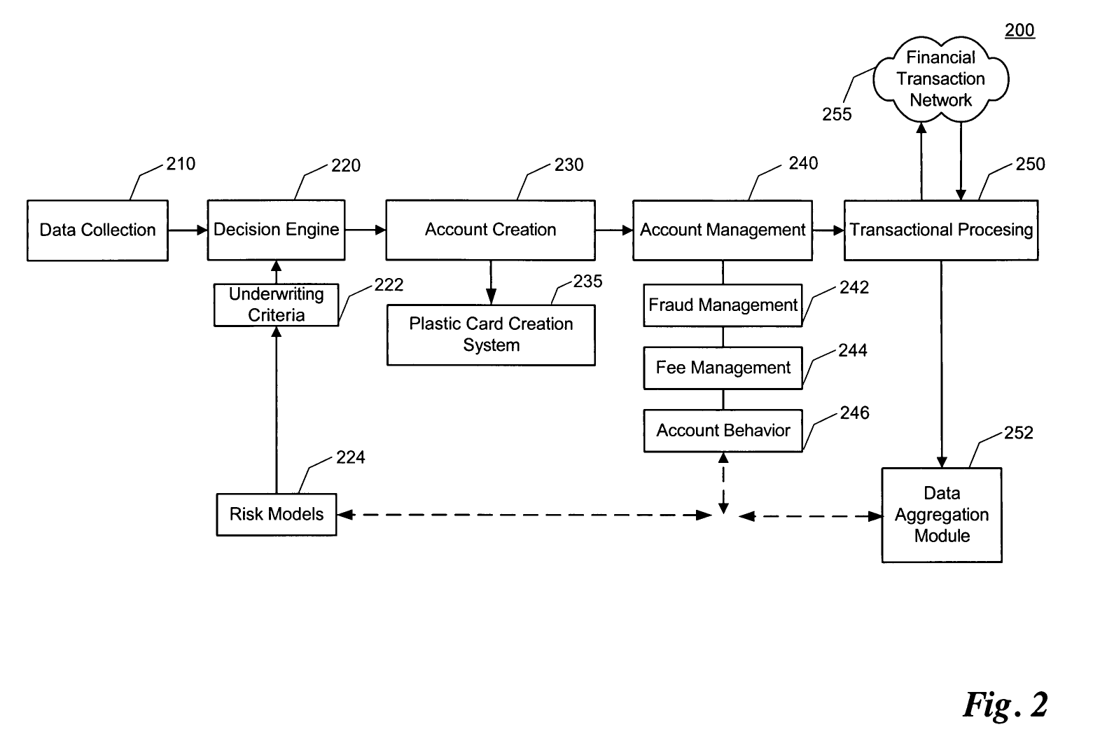

FIG. 2 is a flow diagram 200 illustrating an exemplary embodiment of the present invention. The details of the operation of the flow diagram 200 may vary among various embodiments of the present invention. In general, the illustrated embodiment includes five main functions or components: the data collection component 210, the decision engine 220, the account creation component 230, the account management component 240 and the transactional processing component 250. It should be understood that the structure illustrated in this figure is for discussion purposes only and the various functions or components of the present system could be combined or split in many manners.

The data collection component 210 collects data or information relevant to: opening a credit account (account formation data 212), determining if an applicant can qualify for an account, the type of account to be opened (account option data 214), and other miscellaneous data. The information collected with regards to the account formation data 212 may include, but is not limited to, the applicant's name, date of birth, mailing, residential and business addresses, telephone numbers, social security number or verified government identification number, direct deposit account (DDA) information and account number, savings account information and account number, credit history, debt to credit ratio, assets, marital status, employment history etc.

Further information regarding the account formation data 212, the account option data 214 and the account types can be found in the related application that has been incorporated into this specification by reference. After the data collection component 210 receives the necessary or the minimum amount of information, the decision engine 220 can be begin processing.

The decision engine 220 receives raw or processed data from the data collection component 210 and, among other functions, integrates it with underwriting criteria 222 to determine if a customer qualifies for an account. The underwriting criteria 222 is initially determined using a collection of integrated algorithms, methods of work, business processes, and initial risk modules 224 that enable the analysis, issuance, distribution, and monitoring of an integrated credit product. The initial risk models 224 are compiled from a variety of different sources that vary by issuer and one skilled in the art is familiar with the type of information that is associated with them. In addition to determining if a customer qualifies for an account, the decision engine system 220 also determines if a customer qualifies for any applicable account option data 214 selected in the data collection system 210. For example, if a customer selected an overdraft option in the account option data 214, the decision engine 220 would determine if the customer qualified for that option and, if qualified, the amount of the overdraft limit. The decision engine 220 uses the account formation data 212 to qualify the customer and perform a risk management processes. The customer is subjected to underwriting criteria 222 to determine qualification and some additional data or documents may be required for the process.

Once a customer is qualified, the account creation component 230 proceeds to open an account. The account creation component 230 may perform different functions depending upon the account option data 214. Preferably, the account creation component 230 operates to create an account for the customer in a manner that is in compliance with all applicable local, state and federal laws. During the account creation, the account creation component 230 may utilize various procedures to support issuer risk mitigation requirements. The account creation component 230 also includes a plastic card creation component 235 that operates to generate a permanent card for the customer.

The procedures performed by the account creation component 230 may vary depending on the type of account being created. In the examples provided in the incorporated reference, the three account types include the instant issue card, the basic card and the basic card with overdraft protection. Other functions that may be performed by the account creation component 230 include the activation of the account the issuance of cards. The details of these functions are more specifically described in the incorporated reference.

The account management component 240 manages the customer account by utilizing controllers to enable and disable certain functions and privileges of the account based on various factors. Some of the factors can include account risks and customer behaviors. In one embodiment, the account management component 240 can include the functions of fraud management model 242, fee management model 244 and account behavior model 246. The fraud management model 242 can utilize the operation of the account behavior model 246 to determine if any fraudulent activities are associated with the account. If any fraudulent activities are detected, the account management component 240 can be notified by the fraud management model 242 to suspend the account. The fee management model 244 determines and assesses any applicable fees to be charged against the account. For example, if the account is overdue, a late fee would be assessed to the account. In the various embodiments, additional fees can be assessed against the accounts. For instance, a one time fee may be assessed for the creation of the account or for the creation of certain accounts, such as accounts having an overdraft component 234. In addition, the account may include a fixed number of transactions or a fixed number of transactions per fixed period (i.e. per month). Once the fixed number of transactions is exceeded, additional transactions can be assessed a transaction fee. In another embodiment, a monthly fee may be assessed on the account.

The account behavior model 246 examines account activity and looks for patterns in the account activity to determine possible actions to be taken (i.e. intervention to stop fraud). For example, if an account appeared to have sporadic spending or if the stored value became zero, the account could be turned off temporarily to ascertain if the account is being defrauded. The transactional processing component 250 processes and monitors the day to day transactions between the account and the financial transaction network 255. The transactional processing component 250 is then compiled by the data aggregation module 252.

The data aggregation module 252 may work on data related to the entire population of account holders, groups of populations based on factors such as age, occupation, areas of domicile etc. or even individuals. The data aggregation module 252 provides processed outputs to the risk models 224 and the account behavior 246 model.

A key aspect of the present invention is found in the operation of the account management component 240. The account management component 240 of the present invention enables the dynamic management and alteration of the financial account based on real-time and current information. Two controlling factors are applied to the account management component 240. These controlling factors include the output of risk models 242 that have been run on the initial underwriting criteria collected by the data collection component 210, as well as the output of the data aggregation module 252.

The data aggregation module 252 refines and updates, preferably on a real-time basis, the various current trends of the accounts being managed. This information is then fed into the risk models 224 which determine new underwriting criteria 222, and the account behavior 246 model. The data aggregation module 252 can feed information into the risk models 224 and the account behavior 246 model at periodic intervals, continuously, autonomously, on request, or on other bases. The account behavior model 246 can operate to alter the parameters of the operation of the credit account. The account behavior model 246 can base these alterations on the input from the aggregation module 252 and/or the risk models 224. Thus, in operation, the data aggregation module 252 may identify trends for a particular subset of the population. This information in turn can be used by the risk models 224 to identify certain risks associated with the particular subset or related subsets of the population. This information, as well as the information directly provided from the data aggregation module 252 can serve as the basis for altering the parameters of the credit account. As a particular example, suppose that the data aggregation module 252 identifies an increase in transactions by customers identified as working in the airline sector and the risk models 224 indicate a decline in job stability in the transportation industry. The account behavior model 246 may utilize this information to decrease the lines of credit provided to customers working in the airline sector, increase fees associated with their accounts, provide a higher level of scrutiny on approvals of purchases, lock the account from further purchases, or the like. From a fraud perspective, the account behavior model can receive information from the data aggregation module 252 that may be an indication of fraudulent behavior. The account behavior module 246 can then take actions to limit or alleviate the risk of fraud.

Similarly, the risk models 224 can receive input from the data aggregation module 252 and/or the account behavior model 246. The information fed to the risk models 224 is used as the basis for generating new underwriting criteria for qualifying new individuals for accounts. The new underwriting criterion provides more accurate real-time criteria that are not otherwise available when using underwriting criteria that has only been created at the initial stages of qualification.

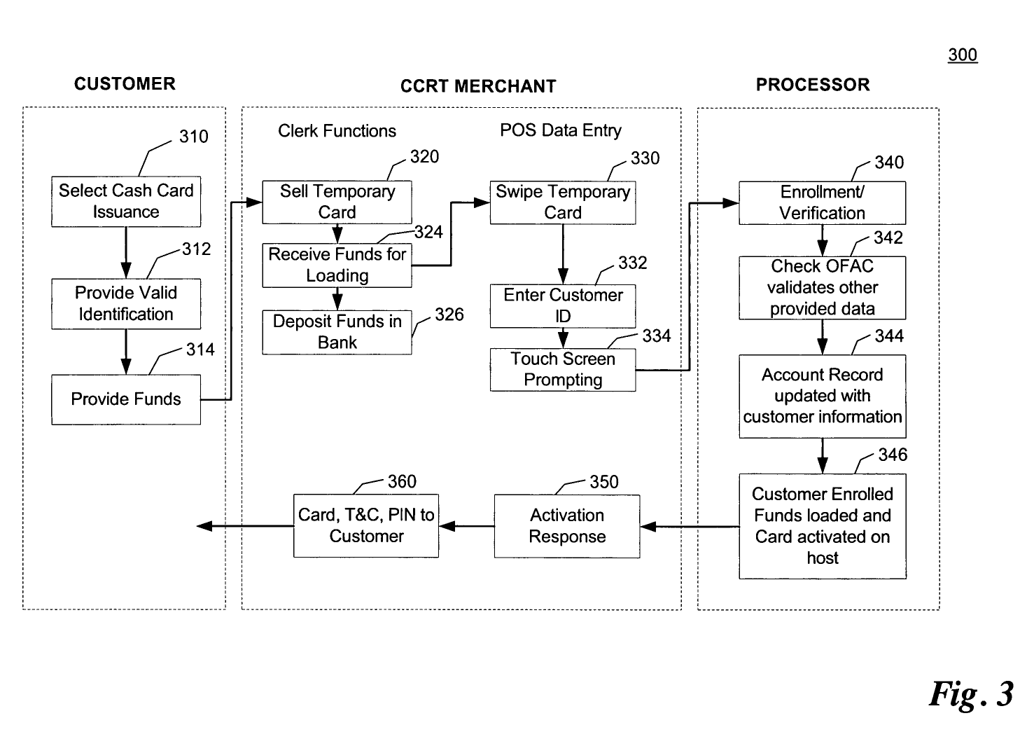

FIG. 3 is a flow diagram illustrating the processes involved in providing the financial service of issuing a cash card to a customer through the use of the multi-function terminal 100 of the present invention 300. Initially a customer approaches a merchant that has a multi-function terminal. The customer selects, or with the help of the merchant, selects the financial option of the issuance of a cash card 310. The customer is then prompted to provide valid identification 312 and funding for the cash card 314.

The merchant's clerk working with the customer initiates the sell of a temporary card 320. The clerk then receives the funding from the customer that will be used for loading value into the cash card 324. Independently the merchant deposits the funds in a banking institution, transfers the funds to an appropriate account or issues a transaction against a credit card 326. In addition, the clerk swipes the temporary card through the terminal 330. The terminal 100 reads the magnetic strip on the back of the temporary card and extracts an identification number for the card. The clerk then enters the identification of the customer 332. The identification can be obtained from the valid identification presented by the customer or through some other means. The clerk then follows one or more steps prompted by the multi-functional terminal. In the illustrated embodiment, this is done through a touch screen on the multi-function terminal 334.

The information collected at this point in the process is passed to a processor that first operates to enroll the customer and verify the information received from the customer 340. The processor then conducts an OFAC check and validates other data provided by the customer 342. An account record is then either created, or updated if this is a repeat customer, with the customer information 344. The processor then operates to enroll the customer, load the provided funds onto a card and activate the card in conjunction with a host or server managing the processor 346.

If the customer is approved, an activation response is provided to the multi-functional terminal 350 and a card, terms and conditions and a PIN is provided to the customer 360. At this point the customer is then able to use the temporary card. In some embodiments, a permanent card will then be created and mailed to the customer.

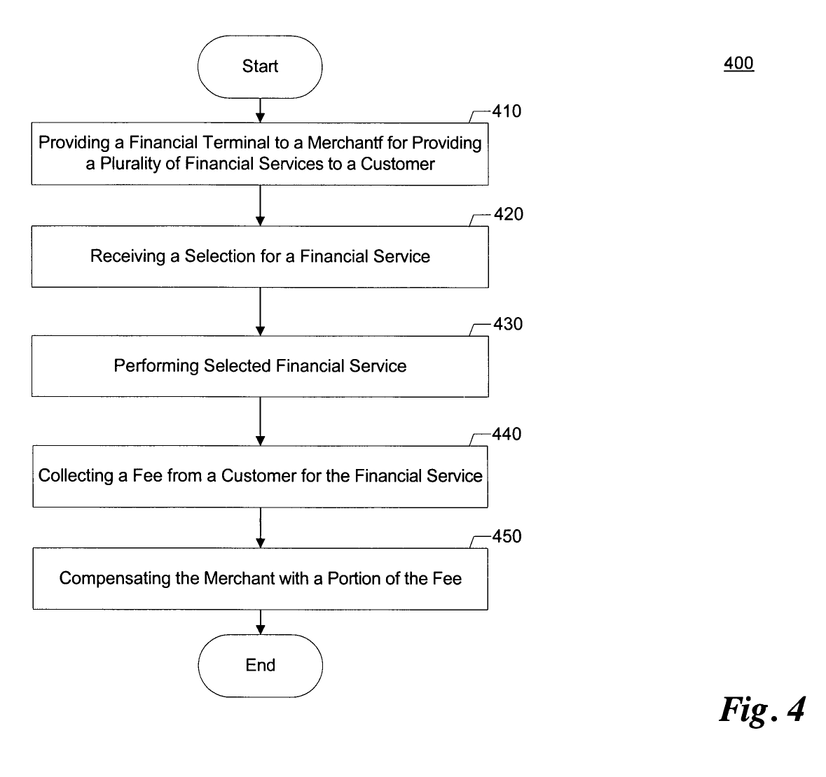

FIG. 4 is a flow diagram illustrating the operation of an exemplary embodiment of the present invention. One aspect of the present invention is providing an entire suite of financial services that are available to a customer, or a customer working with a merchant 400. The first step in providing the suite of financial services 400 is providing a multi-functional terminal to a merchant 410. In conjunction with this, the multi-functional terminal can be integrated into the merchant's communication infrastructure as well as being connected to the server 150 that operates in conjunction with the terminal 100. The multi-functional terminal 100 is operable to provide the suite of financial services to a customer.

Once the multi-functional terminal 100 or terminals are installed and operational at the merchant location, the multi-functional terminal 100 can be access by a customer and/or a merchant to initiate the provision of a financial service selected from the suite of financial services available.

One of the overall purposes of the present invention is to allow customers to have instant access to a suite of financial services at a variety of locations convenient to the customer. Thus, the service provider of the financial services equips multiple merchants with the terminal 100 equipment.

The suite of financial services can be accessed from the multi-functional terminal 100 in a variety of manners. Thus, in an exemplary embodiment, a terminal 100 gives a service provider the ability to identify and process a customer requesting a financial service at a retail merchant point of sale. The terminal 100 operating in conjunction with the server 150 and other resources insures compliance with identification and qualification requirements established by competent authorities and/or the service provider. The merchant makes the terminal 100 available for use by a customer or the merchant operates the terminal 100 on behalf of the customer.

The financial service can include one of several financial services, such as purchasing a stored-value card, transferring of funds, wiring funds, obtaining cash in an ATM fashion, purchasing a pre-paid credit-type card, purchasing a pre-paid telecom card, stamps, etc. at the terminal. One key aspect of the present invention is that a single terminal 100 can provide any and all of these financial services as well as other services.

In one embodiment a menu of services available can be displayed on a screen and selected by a customer and/or merchant. In another embodiment, the customer may swipe a card through the card reader of the terminal 100 and after identifying the customer or card identification, the terminal 100 can indicate the financial services available. In addition, it should be noted that the terminal 100 can operate in conjunction with the server 150 to determine the financial services available to the customer. Regardless of the method of indicating the services available or the method employed for selecting one of the suite of services, the terminal 100 receives a selection for a financial service 420. The selection is made from the plurality of financial services available to the customer.

The selected financial service is performed 430. This process can vary greatly depending on the selected financial service. However, in most situations, the customer is prompted to provide additional information that is entered into the multi-functional terminal 100 in one of the various previous manners disclosed. Once the multi-functional terminal 100 has sufficient information, the multi-function terminal 100 interacts with the server to determine if the financial service can be provided, if the customer qualifies and to verify the information is correct. This process may involve requesting additional information from the customer and/or the merchant. Ultimately, the financial service is provided to the customer.

A fee is collected from the customer for the provision of the financial service 440. As has been described, this fee can be collected in a variety of manners including cash, credit cards, bank transfers or the like.

A key aspect of the present invention is the step of compensating the merchant with a portion of the fee collected from the customer 450. This varies from the current state of the art. Traditionally, merchants have paid a fee to have terminal equipment installed on their premises and/or paid a fee for certain transactions. The system implementation of the present invention utilizes various means for compensating the merchant for housing and operating the equipment at the merchant's location. In one embodiment, the merchant may simply be given a flat fee for each terminal 100. In another embodiment, the merchant may be paid a fee based on the number of terminals 100 and the number of transactions provided using the terminals 100. In yet another embodiment, the merchant may be compensated based solely on the number of transactions. In yet another embodiment, the merchant may be compensated based on a percentage value of the transactions. Those skilled in the art will appreciate that any of these compensation methods, as well as a combination of one or more of these methods maybe utilized and the present invention is not limited to any particular configuration.

The Suite of Services

The present invention can be utilized to provide a suite of financial services to a customer at a variety of merchant locations. The general descriptions of these financial services are provided below.

Stored-Value Card.

For the financial service of purchasing a stored-value card, the customer purchases a pre-paid or stored-value magnetic-type card (the data source 110), from the merchant. The detailed components for this financial service were described in conjunction with FIG. 3. The overall operation of this financial service enables the merchant to initiate and issue a stored-value card. The merchant can accept payment for the card in a variety of manners including cash, credit card, money transfer, check, etc. The merchant may supply and swipe the card through a magnetic card reader (the data interface 120), interfaced to the terminal 100. This process allows the terminal 100 to capture the account number of the card. The merchant may then enter a value for the card into the terminal 100 through the data interface 120. As previously described, this information can be provided to the terminal 100 in a variety of manners including the use of a keyboard, scanner, magnetic card reader or the like. In one embodiment, the merchant may acquire certain additional information from the customer, such as the customer's name, date of birth, social security number, DDA number, etc.). The merchant may then enter this information into the data interface 120 of terminal 100. Although this aspect of the invention is being described as a customer and merchant performing certain tasks, it should be understood that either of the participants could perform the tasks and some of the tasks could even be automated.

Once the merchant has collected all of the information, or even during the information collection process, all or portions of the information are provided to the server 150 through the network interface 140. The server processes the information in a manner that is familiar to those skilled in the art. The incorporated references provide further information regarding this process. The merchant then waits for the terminal 100 to receive authorization from the server 150.

The funds for the stored-value card can be provided by the customer in a variety of manners. In one embodiment, the stored-value card may be funded directly from the customers direct deposit account (DDA), thus the limit of the pre-paid or stored value card is the amount taken from the account and placed on the card. In another embodiment, the stored-value can be funded based on a credit as authorized by the service provider, thus the limit of the card is limited by the amount of credit authorized. The stored-value card can also be funded by a direct cash transaction at the terminal 100. Thus, the value of the stored-value card can be selected by the customer or merchant and as long as funds are available, The authorization of the stored-value card can be based on a number of factors, including, but not limited to, credit worthiness, credit history, credit score, balances in customer accounts, etc. Once an authorization has occurred, the card is activated and a stored value or credit limit is associated with the card. In one embodiment, the activation process may include writing information out to the data source 110, in this case the stored-value card. For instance, the value associated with the stored-value card, an expiration date, an authorized user name, PIN code, terminal 100 and/or merchant at which the card was activated, date of activation, or a variety of other information could be stored on the stored-value card. The customer may then make purchases from the merchant using the pre-paid or stored-value card.

In addition, once a financial service is provided, such as using the stored-value card, the terminal 100 can operate to update the session data after performing a financial service and sends the updated data to the data source 110. The customer can then use the terminal 100 to view activity data, history data or other data associated with the data source 110.

The process for issuing a stored-value card is also applicable to the purchasing a pre-paid credit-type card as well as a pre-paid telecom card.

Transferring of Funds.

For the financial service of conducting a fund transfer, the customer initiates the transfer by selecting the appropriate feature from the terminal 100. The present invention can be used to transfer funds from one account into another account, from a stored-value card to an account, or from an account to a stored-value card. For transferring funds from one card to another, the customer can simply swipe the card through the card reader of the terminal 100 and select an option to transfer the balance, or a portion thereof to another card. The balance can be transferred to another card held by the customer or to another card not even owned by the customer. In this case, the customer will be required to enter a card identification number, account number and/or customer identification information into the terminal 100. The server 150 operates to receive the fund transfer request. If the transfer is a card to card transfer, the server 150 can communicate with the terminal 100 and instruct the customer to swipe the destination card or enter the necessary information to identify the destination for the transfer. If the transfer is to be made to a card not in the customer's possession, the server 150 can receive and maintain information regarding the transfer. Once the system is accessed by the destination card or a card associated with a customer or account destined to receive the transfer, the server 150 can initiate the completion of the transfer. If the funds are destined for an account, the server 150 can transfer the funds directly into the account once the appropriate information is entered. If the transfer request is to transfer funds from an account onto the card, the process is similar to that described in conjunction with the stored-value card financial service.

Wiring Funds.

For the financial service of conducting a wiring fund transfer, the customer initiates the transfer by selecting the appropriate feature from the terminal 100. Similar to the funding options for the stored-value card, the customer can utilize the same options for funding the wiring transfer. The terminal 100 collects the necessary information by prompting the customer for the information. In the alternative, the server 150 can cause the terminal 150 to prompt for specific information. In either case or using a combination of both, the information is collected and transferred to the server. The server then actuates the wire transfer.

Cash-Back.

For the financial service of providing access to cash, the customer initiates the service by selecting the appropriate feature from the terminal 100. The funds to support cash access can be based on a credit card, money transfer, check, etc. The terminal 100 collects the necessary information by prompting the customer for the information. In the alternative, the server 150 can cause the terminal 150 to prompt for specific information. In either case or using a combination of both, the information is collected and transferred to the server. The server 150 then approves the financial service and gives in indication to the terminal 100. This same approach can be applied in the purchase of stamps.

Check Acceptance.

The terminal 100 can also be used to authorize or verify payments by check. The check can be scanned at the terminal 100, and based on the account information, the server 150 can begin to process approval for the payment. The server 150 and or terminal 100 can request additional information from the customer to complete the financial service and the customer can enter that information at the terminal 100.

Bill Payment.

The terminal 100 can be utilized by a customer 150 to pay bills. In operation, the customer enters information to identify the recipient of the bill, along with the amount, source of funds for making the payment, and the like. The terminal 100 and/or server 150 may interact with the customer to obtain additional information. The source of funds can be any of a variety of sources, or a combination of one or more sources, including but not limited to, a stored-value card, banking account, cash, check or the like.

Loyalty awards.

The present invention also anticipates providing a loyalty awards program. As a customer receives financial services

In one embodiment, the merchant charges a fee for the financial service, a portion of which is supplied to the service provider. In another embodiment, the terminal 100 automatically assesses and extracts a fee for a give financial service and apportions the fee appropriately to the merchant and/or the service provider.

In another exemplary embodiment, a terminal 100 interfaces with a templated scanner through the data interface 120. A templated scanner may be utilized where the data source 110 is a non-magnetic or non-bar coded card (i.e. a drivers license, official document, etc.). The templated scanner extracts session data from the data source 110 and transfers the session data to the processor 130. The processor 130 matches the data source 110 to a recognizable format and associates a pre-defined template to the data source 110. The processor 130 then extracts the data within the templated area for use in the authorization process.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

1. A terminal that can be operated by a merchant to provide a plurality of financial services to a customer, the terminal comprising:
a data input interface;
a user interface;
a network interface for communicatively coupling the terminal to a server; and
a processor coupled to said data input interface, said user interface and said network interface and operable to:
receive a financial service selection from the user interface;
extract session data from a data source through said data input interface;
provide said session data to said server;
obtain an authorization from said server to provide the selected financial service; and
provide the selected financial service.

2. The terminal of claim 1, wherein said processor is further operable to request validation of said session data from said server.

3. The terminal of claim 2, wherein said processor is further operable to:
update said session data based at least in part on the provision of the financial service and the validation; and
write the updated session data to the data source through the data interface.

4. The terminal of claim 2, wherein said processor is further operable to:
update said session data based at least in part on the validation; and
write the updated session data to the data source through the data interface.

5. The terminal of claim 1, wherein said processor is further operable to:
update said session data based at least in part on the provision of the financial service; and
write the updated session data to the data source through the data interface.

6. The terminal of claim 1, wherein said data interface includes a magnetic card reader.

7. The terminal of claim 1, wherein said data interface includes a bar code reader.

8. The terminal of claim 1, wherein said data input interface includes a scanner.

9. The terminal of claim 8, wherein said processor is further operable to apply a template to selectively scan portions of the data source in obtaining the said session data.

10. The terminal of claim 1, wherein said at least one financial service includes generating a pre-paid card.

11. The terminal of claim 1, wherein said at least one financial service includes granting approval for accepting a check.

12. The terminal of claim 1, wherein said at least one financial service includes providing cash to a customer.

13. The terminal of claim 1, wherein said at least one financial service includes performing a transfer of funds between a first and second account.

14. The terminal of claim 1, wherein said at least one financial service includes transferring the stored value on a first stored-value card to the balance on a second stored value card.

15. The terminal of claim 1, wherein said at least one financial service includes executing the payment of one or more bills.

16. The terminal of claim 1, wherein said at least one financial service includes generating a pre-paid telecommunications card.

17. A method for providing financial services to a customer, the method comprising the steps of:
providing to a merchant a financial terminal capable of performing a plurality of financial services for a customer;
receiving a selection of a financial service;
performing the selected financial service;
collecting a fee from said customer for said financial service; and
compensating said merchant with a portion of said fee.

18. The method of claim 17, further comprising the step of receiving session data from said customer.

19. The method of claim 18, further comprising the step of receiving authorization from a server for said financial service based at least in part on said session data.

20. The method of claim 18, further comprising the step of updating said session data after completion of said financial service.

21. A system for providing financial services, the system including a terminal and a server coupled said terminal, the system comprising:
said terminal having a network interface for interfacing to said server and a data interface for receiving a data source and being operable to:
extract session data from said data source via said data interface;
receive a financial service selection;
obtain validation from said server; and
perform said selected financial service; and
said server having a network interface for interfacing to said terminal and being operable to:
receive session data from said terminal via said network interface;
validate the selected financial service based in part on said session data; and
send a validation notice to said terminal via said network interface.

22. The system of claim 21, wherein said terminal is further operable to update said session data after performing said selected financial service and send said updated session data to said data source via said data interface.
